(19) United States
(12) Patent Application Publication
(10) Pub. No.: US 2005/0277100 A1
(43) Pub. Date: Dec. 15, 2005

(54) Dynamic construction of games for on-demand e-learning

(75) Inventors: Elizabeth Vera Bagley, Cedar Park, TX (US); Blake Osborne Goulette, Apex, NC (US); Pamela Ann Nesbitt, Tampa, FL (US); Robert Christopher Pepper, Raleigh, NC (US); Ronald Gary Shapiro, Providence, RI (US)

Correspondence Address: David R. Irvin;IBM Corporation T81/503, PO Box 12195, Research Triangle Park, NC, 27709, US

(73) Assignee: International Business Machines Corporation, Armonk, NY (US)

(21) Appl. No.: 10/853,298

(22) Filed: May 25, 2004

(51) Int. Cl. G09B 7/00

(52) U.S. Cl. 434/323; 434/362

(57) ABSTRACT

An e-learning game generator accesses a learning object repository, a learning object assessment object repository, and a video repository. The video repository includes scenes that are suggestive of success and failure of the student in answering questions from the learning object assessment objects. When a student answers a question correctly, the game generator selects a positive scene from the video repository and presents it to the student; when the student answers a question incorrectly, the game generator selects a negative scene and presents it to the student.

### FIELD OF THE INVENTION

The invention relates to the field of electronic learning, and more specifically to methods, apparatus, and computer program products for providing on-demand electronic learning through the dynamic construction of games.

### BACKGROUND

Electronic learning, or more concisely e-learning, is a rapidly growing industry, which, by some estimates, will soon become one of the most widespread applications of the world wide web, to be outdone only by e-mail and search engine applications.

Two important e-learning trends have emerged. One trend is the growing interest in using games to enhance the learning experience. A significant deterrent to the use of games, however, is the cost of creating a customized game for each e-learning experience. The cost of creating a game for an assessment or quiz is prohibitive when compared with the overall cost of developing a course, because the creation of each custom game involves a team of graphic artists, programmers, instructional designers, editors, content developers, and the like.

The other trend in e-learning is an increasing focus on using small, discrete, just-in-time and just-for-me learning objects or modules that comply with agreed standards. These objects can be combined by instructors into larger courses that address specific needs, and they can be dynamically assembled, i.e., self-configured, for on-demand presentation to a student based on criteria provided by the student.

The dynamic assembly of learning objects poses a heretofore insurmountable obstacle to the incorporation of games into the learning environment, however, as it may be impossible to know beforehand which learning objects a student or a content developer will choose, or what order the objects will appear in. As a result, today, a game can be created neither dynamically nor economically in advance. Thus there is a need for a way to create games economically, dynamically, and on-demand, to improve the e-learning experience.

### SUMMARY

According to one aspect of the invention, a game generator accesses a learning object repository, a learning object assessment object repository, and a video repository. The video repository includes positive scenes that are suggestive of success and negative scenes that are suggestive of failure, which are dynamically selected for presentation to students in response to their answers to questions from the learning object assessment objects. When a student answers a question correctly, the game generator selects a positive scene from the video repository and presents it to the student; when the student answers a question incorrectly, the game generator selects a negative scene and presents it to the student.

### BRIEF DESCRIPTION OF THE DRAWINGS

FIG. 1 is a block diagram that shows exemplary structure according to the present invention.

FIG. 2 is an exemplary flowchart that shows the assembly of questions, responses, and correct answers into a game list by the game generator of FIG. 1.

FIG. 3 is an exemplary flowchart that shows how a game assembled according to FIG. 2 may be presented to a student.

### DETAILED DESCRIPTION

Aspects of the present invention include methods, apparatus, and computer program products for dynamically creating e-learning games. Learning objects for the game may be selected from a repository that conforms to the industry-standard Sharable Content Object Reference Model (SCORM). Examples of SCORM-conformant repositories include a Learning Management System (LMS) for the case where objects are dynamically assembled for delivery to a student, and a Learning Content Management System (LCMS) for the case where small objects are selected for assembly into larger courses by content developers. In both of these cases, the present invention provides the capability to add game features dynamically to assessments.

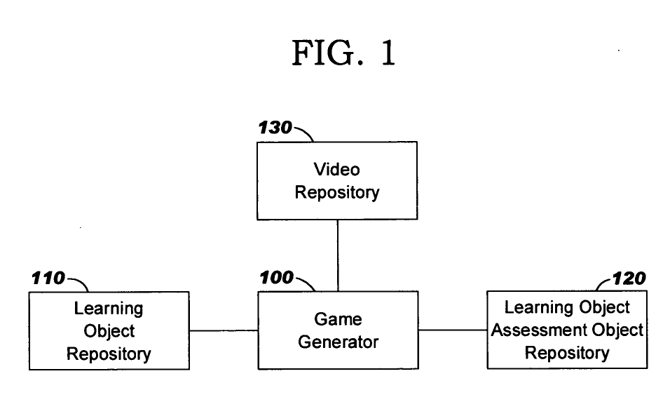

FIG. 1 shows exemplary structure of aspects of the invention. Here, a game generator 100 accesses a learning object repository 110, which holds learning objects that provide instruction to the student; a learning object assessment object repository 120, which holds learning object assessment objects that include sets of questions, multiple-choice responses, and correct answers; and a video repository 130, which stores video scenes. Although the repositories are shown as independent entities in FIG. 1 for descriptive clarity, the three repositories may be combined into a single repository, or any two of the repositories may be combined.

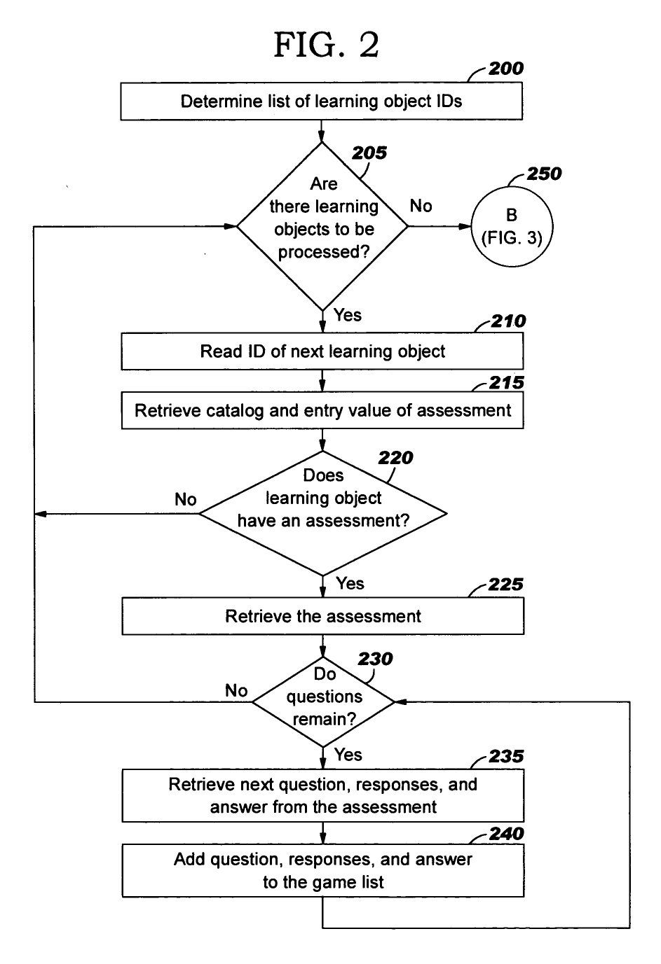

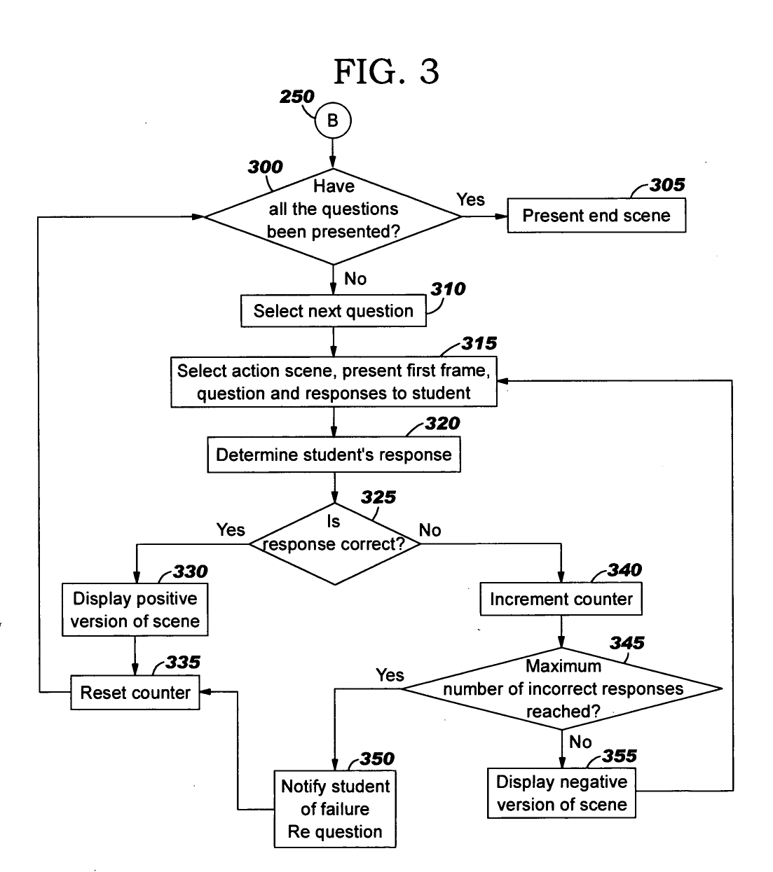

The game generator 100 may be implemented using programmable logic such as a microprocessor, for example as part of a personal computer, workstation, server, or the like, which may also include the repositories. Aspects of the operation of the game generator 100 are described in detail below with reference to FIG. 2 and FIG. 3.

The learning object repository 110 and the learning object assessment object repository 120 may be stored in a Learning Content Management System (LCMS), a Learning Management System (LMS), or any other repository, which, for descriptive purposes, may be called here generically a repository. In preferred embodiments of the invention, the repositories comply with the IEEE Standard for Learning Object Metadata (LOM) 1484.12.1, which may be found at http://ltsc.ieee.org/wg12, or with the Sharable Content Object Reference Model (SCORM), Version 1.2, the SCORM Content Aggregation Model, which is available on the Advanced Distributed Learning (ADL) site http://www.adlnet.org.

Assessments may have the following optional metadata tags defined, in addition to any metadata entities required by SCORM:
Seven Relation container object Relation.Kind, specified using best-practice IEEE LOM vocabulary from Dublin Core to be References; the Dublin Core Metadata Initiative is described in detail at http://dublincore.org/
Relation.Resource container object
Relation.Resource.Description, which describes the referenced object as an assessment object; for example, the description may be simply “assessment”
Relation.CatalogEntry container object
Relation.CatalogEntry.Catalog, which identifies the catalog used to identify and locate the assessment object
Relation.CatalogEntry.Entry, which is used to locate the assessment object.

The video repository 130 stores videos, scenes from which are used in the games. Each video may comprise a start scene, one or more action scenes, and a stop scene. The start scene may show a starting action sequence depicting a starting point. For example, a starting line may appear in a video that involves down-hill skiing, a starting flag may be waved in a video that involves automobile racing, and so forth.

Any number of action scenes may be included in the video repository. It is not necessary that the scenes taken together provide coherent entertainment. Rather, in a preferred embodiment of the invention, each scene can stand alone, and does not necessarily depend sequentially upon previous or subsequent action scenes. However, each preferably ties into a game topic or motif as suggested by the start scene. For example, action scenes for a game with a snowboarding motif may each include a single trick such as a “tailgrab,” an “inverted aerial,” or an “alley oop.” The game topic or motif may be predetermined by a content designer, or selected by a student.

Each action scene has a positive and a negative version, where the two versions may have the same, or substantially similar, first frames. The positive version, which suggests a positive outcome of an activity according to the game motif, is displayed when the student responds correctly to an assessment question, whereas the negative version, which suggests failure, is displayed when the student responds incorrectly. For example, the negative version of an action scene for a game with a snowboarding motif may show someone tumbling in the snow.

The end scene depicts an ending action sequence. The end scene may suggest completion of the learning experience in the context of the motif, showing, for example, a skier or a race car crossing a finish line.

FIG. 2 is a flowchart that illustrates aspects of the operation of the game generator 100, directed here toward constructing a game list of questions, multiple-choice responses, and correct answers from the learning object assessment object repository 120, for learning objects from the learning object repository 110. The game generator determines a list of learning object IDs (step 200). It is important to note that the list of learning object IDs may be set up a priori by a content designer during a design phase long before the game is played, or may be set-up by a student as preparation just before playing the game, or may be determined on-demand as a self-configured game executes. The more general point is that the game according to the present invention is dynamic, so that the learning objects, learning object assessment objects, and video scenes do not necessarily need to be selected and mutually associated before the game is played.

The game generator 100 determines whether there are any further learning objects on the list of learning object IDs to be processed (step 205). If so, the game generator 100 reads the ID of the next learning object in the list (step 210); retrieves the catalog and entry value of the referenced learning object assessment object (step 215), which, for convenience, is called here simply an assessment; and determines whether the learning object has an associated assessment (step 220). If the determination is that the learning object does not have an assessment, the operation of the game generator 100 returns to determine whether there are any further learning objects to be processed (step 205).

Otherwise (i.e., the determination is that the object has an assessment), the game generator 100 uses the catalog and entry values to retrieve the assessment associated with the learning object (step 225). A determination is made as to whether any additional questions of the assessment remain (step 230). If no additional questions remain, the operation of the game generator 100 returns to determine whether there are any further learning objects to be processed (step 205).

Otherwise (i.e., at least one further question remains), the game generator 100 retrieves the next question and its related multiple-choice responses and correct answer (step 235); adds the question, the responses, and the correct answer to the game list (step 240); and returns to determine whether any additional questions of the assessment remain (step 230).

When the determination in Step 205 is that there are no further learning objects to be processed, construction of the game list from the questions, responses, and correct answers is now complete. The game generator 100 then presents the game to the student according to the exemplary process illustrated by the flowchart of FIG. 3 (step 250).

As shown in FIG. 3, the game generator 100 determines whether all of the questions from the game list have been presented to the student (step 300). If all of the questions have been presented, which means that the game is over, the game generator selects an end scene from the video repository 130 for display to the student, and the process ends (step 305). Otherwise (i.e., at least one question from the game list has not been presented to the student), the game generator selects the next question on the game list (step 310), and selects an action scene from the video repository 130, the first frame of which is presented to the student, along with the question and the associated multiple-choice responses (step 315). The video scene may be selected at random, or sequentially, or in any other order from the video scenes having the same game motif in the video repository 130.

The game generator 100 determines the student's response to the question (step 320), and compares the student's response with the correct answer to determine whether the student's response is correct (step 325). If the student's response is correct, the game generator 100 selects the positive version of the scene for display to the student (step 330), resets an incorrect-response counter that begins at zero and counts the number of incorrect responses to the question (step 335), and returns to determine whether all of the questions from the game list have been presented to the student (step 300).

Otherwise (i.e., the student's response is not correct in Step 325), the game generator 100 increments the incorrect-response counter (step 340), and compares the value of the counter with a predetermined threshold to determine whether the student has reached a predetermined maximum number of incorrect responses (step 345). If the maximum number of incorrect responses has been reached, the student is notified of failure regarding the question (step 350), the incorrect-response counter is reset to zero (step 335), and the game generator returns to determine whether all of the questions from the game list have been presented to the student (step 300). If the maximum number of incorrect responses has not been reached, the negative version of the scene is selected for display to the student (step 355), and the game generator returns to Step 315 to begin on another question.

The division of function between FIG. 2 and FIG. 3 is made here only for descriptive convenience. The two processes need not necessarily run sequentially. Alternatively, the two may be intertwined to run together, or a self-configured game may be played for one learning object according to FIG. 3 while a game list is being assembled for another learning object according to FIG. 2.

The present invention also encompasses computer program products, including program storage devices readable by a machine, tangibly embodying programs of instructions executable by the machine for implementing the methods and apparatus described above. The program storage device may take the form of any media that can contain, store, communicate, propagate, or transport the program for use by the machine. These media include, for example, computer diskettes, RAM, ROM, CD, EPROM, communication media for transferring instructions, and the like.

Although the foregoing has described methods, apparatus, and computer program products for the dynamic construction of games for e-learning, the description is illustrative of the invention rather than limiting, and the invention is limited only by the appended claims.

1. Apparatus for dynamic construction of e-learning games, said apparatus comprising:
at least one learning object assessment object;
a repository comprising a plurality of video scenes; and
means for associating a video scene, selected from the plurality of video scenes, with an assessment question from the at least one learning object assessment object, dynamically responsive to an answer to the assessment question by a student.

2. Apparatus for dynamic construction of e-learning games, said apparatus comprising:
a learning object repository for learning objects;
a learning object assessment object repository for assessments;
a video repository for video scenes; and
a game generator for generating a game from learning objects selected from the learning object repository, where the game includes an assessment question from the learning object assessment object repository, and, dynamically responsive to an answer to the question by an e-learning student, selecting a video scene from the video repository for display to the student.

3. The apparatus of claim 2, wherein the video scene is selected at random from a plurality of video scenes having a substantially common motif.

4. The apparatus of claim 2, wherein the video repository includes a positive version and a negative version of the video scene.

5. The apparatus of claim 4, wherein the game generator selects the positive version of the video scene from the video repository in response to a correct answer to the question by the student, and selects the negative version of the video scene from the video repository in response to an incorrect answer to the question by the student.

6. The apparatus of claim 2, wherein the video repository includes a plurality of video scenes, each video scene of the plurality comprising a start scene, at least one action scene having a positive version and a negative version, and an end scene.

7. The apparatus of claim 6, wherein the first frame of the positive version of a given action scene and the first frame of the negative version of the given action scene are substantially the same.

8. A method for constructing e-learning games dynamically, comprising the acts of:
selecting a learning object from a repository of learning objects;
selecting a learning object assessment object associated with the learning object from a repository of learning object assessment objects;
testing an e-learning student according to an assessment question from the learning object assessment object; and
selecting a video scene from a video repository, responsive to an answer to the question by the student, for display to the student.

9. The method of claim 8, wherein the video scene is selected at random from a plurality of video scenes having a substantially common motif.

10. The method of claim 8, wherein the video repository includes a positive version and a negative version of the video scene.

11. The method of claim 10, wherein the positive version of the video scene is selected from the video repository in response to a correct answer to the question by the student, and the negative version of the video scene is selected from the video repository in response to an incorrect answer to the question by the student.

12. The method of claim 10, wherein the first frame of the positive version of the video scene and the first frame of the negative version of the video scene are substantially the same.

13. A program storage device readable by a machine, tangibly embodying a program of instructions executable by the machine to perform method steps for constructing e-learning games dynamically, said method steps comprising:
selecting a learning object from a repository of learning objects;
selecting a learning object assessment object associated with the learning object from a repository of learning object assessment objects;
testing an e-learning student according to an assessment question from the learning object assessment object; and
selecting a video scene from a video repository, dynamically responsive to an answer to the question by the student, for display to the student.

14. The program storage device of claim 13, wherein the video scene is selected at random from a plurality of video scenes having a substantially common motif.

15. The program storage device of claim 13, wherein the video repository includes a positive version and a negative version of the video scene.

16. The program storage device of claim 15, wherein the positive version of the video scene is selected from the video repository in response to a correct answer to the question by the student, and the negative version of the video scene is selected from the video repository in response to an incorrect answer to the question by the student.

17. The program storage device of claim 15, wherein the first frame of the positive version of the video scene and the first frame of the negative version of the video scene are substantially the same.
